(19) United States
(12) Patent Application Publication
(10) Pub. No.: US 2006/0052026 A1
(43) Pub. Date: Mar. 9, 2006

(54) Method of producing field emission type cold-cathode device

(75) Inventors: Seung Hyun Ra, Sungnam (KR); Jong Myeon Lee, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Samsung Electro-Mechanics Co., Ltd., Suwon (KR)

(21) Appl. No.: 11/000,196

(22) Filed: Dec. 1, 2004

(30) Foreign Application Priority Data
Sep. 3, 2004 (KR) 2004-70293

(51) Int. Cl. H01J 9/14; H01J 9/04; H01J 9/12

(52) U.S. Cl. 445/50; 445/49; 445/51

(57) ABSTRACT

Disclosed herein is a simplified method of producing a field emission type cold-cathode device, which can reduce the number of processes required to produce the field emission type cold-cathode device. The method includes applying an insulating material on a mesh-shaped thin conductive metal film to a predetermined thickness to integrally form a gate and an insulating layer, or simultaneously forming an insulating layer and a spacer on a mesh-shaped thin conductive metal film, and subsequently mounting the resulting structure on an upper side of a cathode.

### RELATED INVENTION

The present application is based on, and claims priority from, Korean Application Number 2004-70293, filed Sep. 3, 2004, the disclosure of which is incorporated by reference herein in its entirety.

### BACKGROUND OF THE INVENTION

1. Field of the Invention

The present invention relates generally to a method of producing a field emission type cold-cathode device and, more particularly, to a method of producing a field emission type cold-cathode device, which can reduce the number of processes and is simple.

2. Description of the Related Art

Using a thermion emission phenomenon, in which, when a metal is heated to high temperatures, electrons from the atoms constituting the metal are emitted into the environment, a cathode-ray-tube (CRT) has been conventionally used as an image display device for displaying a color moving picture. However, the image display device adopting a cathode-ray-tube method must be provided with an electron gun for emitting an electron beam, which has a predetermined size, and a unit for accelerating emitted electrons until they reach a screen. Thus, a larger screen requires a longer rear portion of the device. Accordingly, the image display device adopting the cathode-ray-tube method is disadvantageous in that it occupies a large space and is difficult to move because it is heavy.

Recently, many studies have been made to avoid the above disadvantages, resulting in commercialization of flat display devices, such as TFT-LCD, OLED, PDP, and FED (field emission display), which have a short rear part of a screen and are light in weight, as next generation image display devices.

A field emission type cold-cathode device is an electron source provided in the FED, and functions as a device for scanning electron beams to unit screen sections divided like a baduk board, that is, an oriental chessboard, thereby enabling a luminescent material of a screen to emit light.

The field emission type cold-cathode device includes a substrate, an emitter emitting electrons by the application of power (for example, carbon nano tube: CNT), a cathode for application of an electrical signal, a gate, an anode, and an insulating layer for isolating the cathode and the gate from each other. The field emission type cold-cathode device may also include a spacer for maintaining an interval between the anode and the cathode.

The field emission type cold-cathode device may be classified into devices having two-, three-, and four-electrode structures according to the number of electrodes included therein. The device includes only the cathode and anode for the two-electrode structure; the cathode, gate and anode for the three-electrode structure; and the cathode, first and second gates, and anode for the four-electrode structure.

FIG. 5 sequentially illustrates a conventional procedure of producing a field emission type cold-cathode device having a three-electrode structure. In a production of the field emission type cold-cathode device, a lower electrode 52 is first formed on a predetermined substrate 51 made of glass. Subsequently, an insulating layer 53 made of a nonconductive material, such as photoresist, is applied on an upper side of the lower electrode 52 in a predetermined thickness, a mask pattern 54 is applied on an upper side of the insulating layer 53, and the insulating layer 53 is etched according to a lithography process to be patterned. Thereby, the patterned insulating layer 53a has a mesh shape including a plurality of rows and columns.

Next, the mask pattern 54 is removed, a gate 55 is formed on an upper side of the insulating layer 53a, and a CNT is applied on an exposed portion of the lower electrode 52 to form a cathode 56.

Additionally, an anode 57 is formed apart from the cathode 56 by a predetermined distance. A fluorescent layer is formed on a whole side of the anode 57, thereby emitting light due to electrons emitted from the cathode 56.

At this time, spaces between the cathode 56 and anode 57 are in a vacuum state, and allow the electrons emitted from the cathode 56 to move therethrough.

In the resulting structure, when a predetermined voltage is applied to the lower electrode 52 and the gate 55, the electrons are emitted from the cathode 56, and the emitted electrons collide against the fluorescent layer formed on the whole side of the anode 57, thereby emitting light.

At this time, the insulating layer 53a implements an insulating function obstructing the transmission of electricity between the gate 55 and the cathode 56.

According to the conventional procedure, many processes, such as formation of the mask pattern, etching using the lithography process, and removal of the mask, must be carried out so as to form the insulating layer 53a and the gate 55. Furthermore, since an electrode material must be not plated on the cathode 56 during a plating process for forming the gate 55, the cathode 56 is formed after the gate 55 is formed. Accordingly, the lower electrode 52 connected to the cathode 56 must be formed below the cathode 56. Therefore, the conventional procedure is disadvantageous in that the number of processes increases and the procedure is complicated.

### SUMMARY OF THE INVENTION

Accordingly, the present invention has been made keeping in mind the above problems occurring in the prior art, and an object of the present invention is to provide a simplified method of producing a field emission type cold-cathode device, in which the number of processes is reduced.

In order to accomplish the above object, the present invention provides a method of producing a field emission type cold-cathode device, which comprises applying an insulating material on a thin conductive metal film in a predetermined thickness; simultaneously forming a gate and an insulating layer, which have a mesh structure and are attached to each other, by etching the thin metal film and insulating material; forming a cathode on a predetermined substrate; and mounting the insulating layer on an upper side of the cathode so that the cathode, insulating layer, and gate are sequentially laminated.

In the method, the insulating layer may be formed on only one side of the thin metal film. The method may further comprise forming a spacer made of an insulating material on an upper side of the gate after the cathode, insulating layer, and gate are sequentially laminated.

Furthermore, the applying of the insulating material on the thin metal film may include forming first and second insulating layers on both sides of the thin metal film. In such a case, the one insulating layer obstructs the transmission of electricity between the cathode and the gate, and the other acts as a spacer for maintaining a space between a fluorescent layer and an electron emitting part.

Additionally, in the case of the cold-cathode device having a four-electrode structure, the applying of the insulating material on the thin conductive metal film to a predetermined thickness comprises forming a first insulating layer on a first thin conductive metal film, forming a second thin conductive metal film on an upper side of the first insulating layer, and forming a second insulating layer on an upper side of the second thin conductive metal film.

As well, in the method of producing the field emission type cold-cathode device according to the present invention, the forming of the insulating layer and gate comprises forming a mask pattern using a photoresist on an upper side of the insulating layer; and etching the remaining portion of the insulating material other than a portion protected by the mask pattern. The mask pattern may be mounted on the cathode to be used as the insulating layer.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flow chart illustrating the production of a field emission type cold-cathode device according to the present invention;

FIG. 2 illustrates the production of a field emission type cold-cathode device having a three-electrode structure according to the first embodiment of the present invention;

FIG. 3 illustrates the production of a field emission type cold-cathode device according to the second embodiment of the present invention, which has a three-electrode structure including a spacer;

FIG. 4 illustrates the production of a field emission type cold-cathode device having a four-electrode structure according to the third embodiment of the present invention; and

FIG. 5 illustrates the conventional production of a field emission type cold-cathode device.

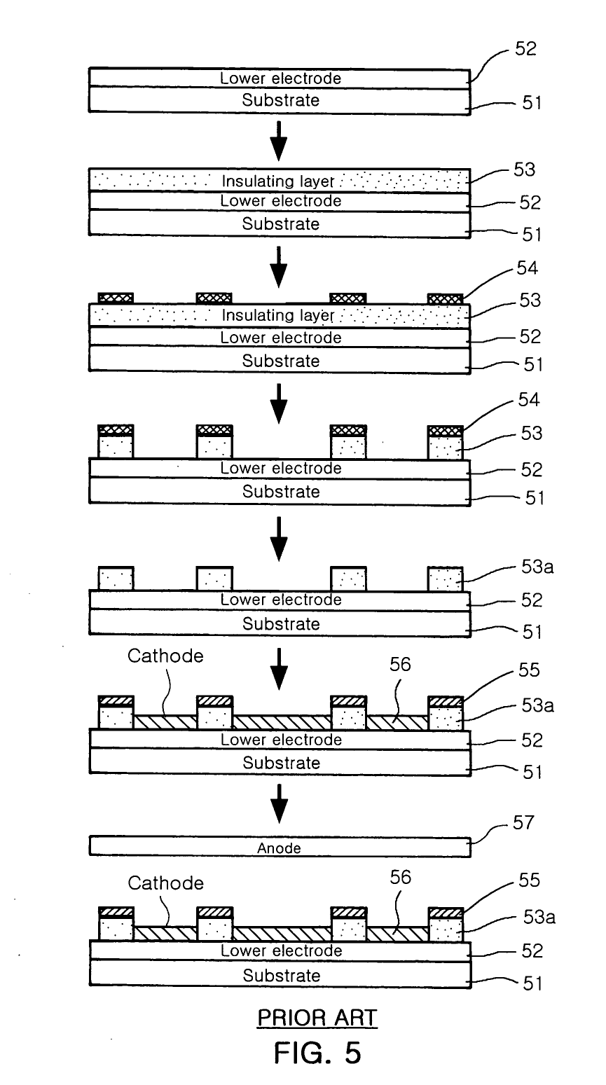

### DESCRIPTION OF THE PREFERRED EMBODIMENTS

Hereinafter, a detailed description will be given of a method of producing a field emission type cold-cathode device according to the present invention, referring to the drawings.

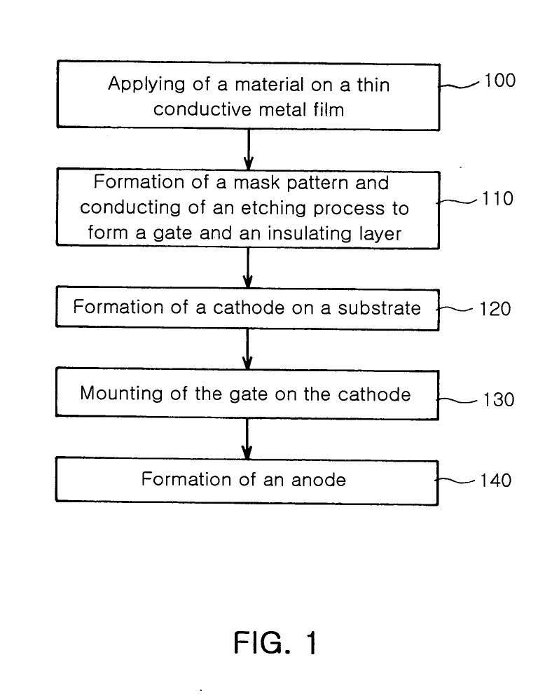

FIG. 1 is a flow chart showing a basic procedure of producing a field emission type cold-cathode device according to the present invention.

Unlike a conventional method, in the method of producing the field emission type cold-cathode device according to the present invention, after an insulating layer and a gate are separately formed, an upper side of the gate is mounted on a substrate. Accordingly, the necessity for an additional sacrificial substance, which was conventionally required to protect other electrodes in the course of forming the gate, is removed and the mounting of the gate is conducted after a cathode is formed, thereby reducing the number of processes.

In other words, in the method of producing the field emission type cold-cathode device according to the present invention as shown in FIG. 1, a thin metal film made of a predetermined conductive material is provided, and the insulating layer is formed on the thin metal film at stage 100. The thin metal film is intended to form the gate of the cold-cathode device, and it is preferable that the thin metal film be made of a conductive metal, for example copper (Cu), so as to transmit an electrical signal there through.

Subsequently, a mask pattern is applied on an upper side of the insulating layer, and the insulating layer and the thin metal film are simultaneously etched according to a lithography process to form the gate integrated with the insulating layer at stage 110.

After the cathode including a CNT to be used as an emitter is formed on the substrate made of glass at stage 120, the insulating layer on the upper side of the preformed gate is mounted on the cathode at stage 130. Thereby, the cathode, the insulating layer, and the gate are sequentially laminated.

Next, an anode is formed apart from the cathode by a predetermined distance at stage 140. The formation of the anode is implemented according to the conventional method.

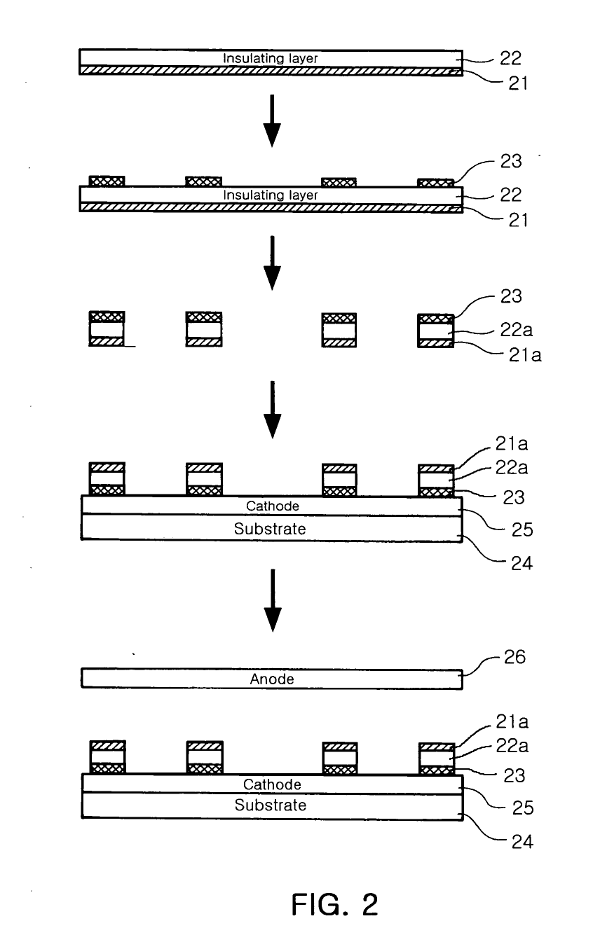

A description will be given of the production of the field emission type cold-cathode device according to the method of the present invention, referring to FIGS. 2 to 4.

FIG. 2 illustrates the production of a field emission type cold-cathode device according to the first embodiment of the present invention, which has a three-electrode structure consisting of a cathode, a gate, and an anode. As described above, a predetermined thin conductive metal film 21 is provided, and an insulating material is applied on an upper side of the thin metal film 21 in a predetermined thickness to form an insulating layer 22.

Additionally, a mask pattern 23 having a predetermined shape is formed on an upper side of the insulating layer 22, and the insulating layer 22 and the thin metal film 21 are simultaneously etched according to a lithography process to form a mesh-shaped gate 21a and insulating layer 22a. At this time, the mask pattern 23 may be removed, but it is preferable that it not be removed so as to reduce the number of processes. In this regard, since the mask pattern 23 is made of an insulating material, such as photoresist, it may act as the insulating layer if it is not removed.

Separately, a cathode 25, including a CNT to be used as an emitter, is formed on an upper side of a substrate 24 made of glass.

As described above, after the substrate 24, on which the cathode 25 is formed, the mesh-shaped insulating layer 22a and the gate 21a are provided, the insulating layer 22a is mounted on an upper side of the cathode 25.

At this time, the CNT is already applied on the upper side of the cathode 25 prior to the mounting of the insulating layer 22a. Alternatively, as in the a conventional method, after a lower electrode is formed on the upper side of the substrate 24 and the insulating layer 22a and gate 21a are then mounted on the lower electrode, the CNT may be applied on only an exposed portion of the lower electrode to form the cathode 25. However, in the present invention, the formation of the insulating layer 22a and the gate 21a is conducted through a separate process from the formation of the cathode. Therefore, even though the insulating layer 22a and the gate 21a are directly formed on the upper side of the cathode 25, problems, such as damage to the cathode 25, do not occur.

Subsequently, the anode 26 is formed apart from the cathode 25 by a predetermined distance.

The insulating layer 22a implements an insulating function of obstructing the transmission of electricity between the cathode 25 and the gate 21a. Additionally, since the mask pattern 23 is usually made of an insulating photoresist, it may be used as the insulating layer 22a.

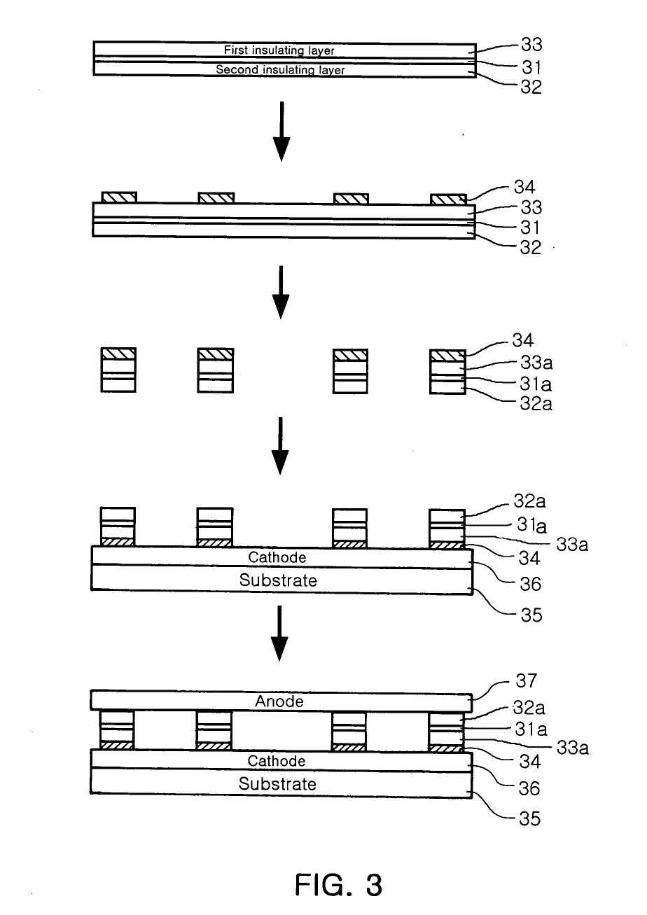

FIG. 3 illustrates the production of a field emission type cold-cathode device according to the second embodiment of the present invention, which has a three-electrode structure.

With reference to FIG. 3, the second embodiment is different from the first embodiment in that in the course of forming an insulating layer on a predetermined thin conductive metal film 31 at stage 100, first and second insulating layers 32, 33 are formed on lower and upper sides of the thin conductive metal film 31, respectively. However, formation of a mask pattern 34 and etching, and formation of a cathode 36, and formation of an anode 37 are conducted according to the same procedure as FIG. 2.

In other words, an insulating material is applied on the upper and lower sides of the predetermined thin conductive metal film 31 to form the second and first insulating layers 33, 32 in predetermined thickness.

Additionally, after the mask pattern 34 is formed on any one (for example, on an upper side of the second insulating layer 33) of the first and second insulating layers 32, 33 to form a mesh structure, an etching process is carried out to simultaneously etch the first insulating layer 32, the thin metal film 31, and the second insulating layer 33. Thereby, the mesh-shaped first insulating layer 32a, gate 31a, and second insulating layer 33a are created.

As described above, the cathode 36 including a CNT is formed on an upper side of a predetermined substrate 35.

At this time, either one of the first and second insulating layers 32a, 33a functions as an insulating unit for obstructing the transmission of electricity between the cathode 36 and the gate 31a, and the other acts as a spacer for maintaining a predetermined interval between the anode 37 and the cathode 36.

Subsequently, the second insulating layer 33a is mounted on the cathode 36, and the anode 37 is formed on an upper side of the first insulating layer 32a.

Accordingly, in the second embodiment, the second insulating layer 33a serves to transmit electricity between the gate 31a and the cathode 36, and the first insulating layer 32a acts as the spacer for maintaining a predetermined interval between the cathode 36 and the anode 37.

In the cold-cathode device having the three-electrode structure, the spacer for maintaining the predetermined interval between the anode and the cathode may be formed through a separate process. In other words, as shown in FIG. 2, after the insulating layer is formed on one side of the thin metal film and then mounted on the cathode, a lattice-shaped spacer made of an insulating material, such as glass, may be mounted on an upper side of the gate.

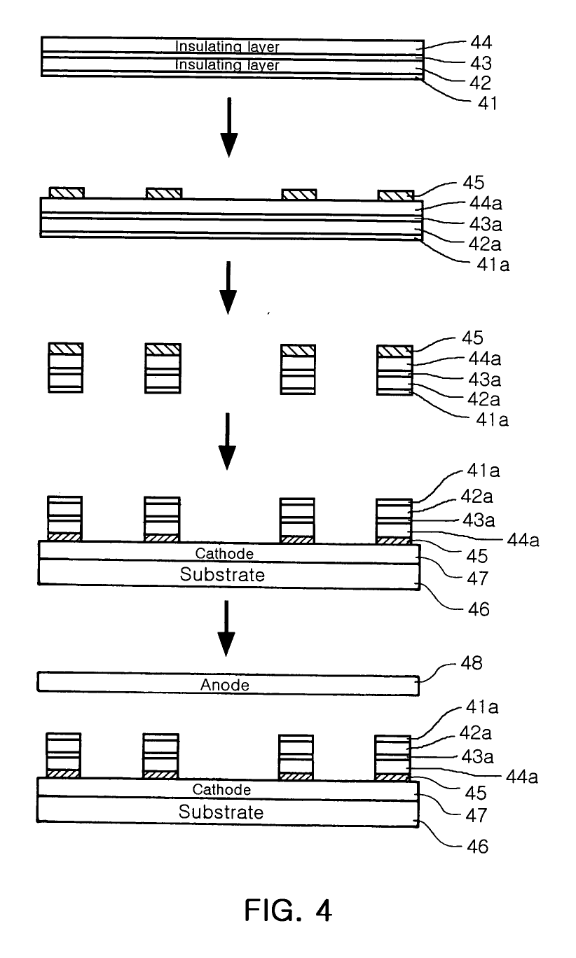

FIG. 4 illustrates the production of a field emission type cold-cathode device having a four-electrode structure according to the third embodiment of the present invention.

The field emission type cold-cathode device having the four-electrode structure is provided with two gates between an anode and a cathode. In order to form the two gates, a first insulating layer 42 is formed on a conductive first thin metal film 41, a conductive second thin metal film 43 is formed on an upper side of the first insulating layer 42, and a second insulating layer 44 is formed on an upper side of the second thin metal film 43.

Furthermore, a mask pattern 45 is formed on an upper side of the second insulating layer 44 to form a mesh structure, and the resulting structure is etched through a lithography process, thereby simultaneously creating the mesh-shaped first gate 41a, first insulating layer 42a, second gate 43a, and second insulating layer 44a.

Thereafter, the second insulating layer 44a is mounted on the cathode 47 formed on a predetermined substrate 46. Subsequently, the anode 48 is formed apart from the cathode 47 by a predetermined distance.

The etched first insulating layer 42a obstructs the transmission of electricity between the first and second gates 41a, 43a, and the second insulating layer 44a obstructs the transmission of electricity between the second gate 43a and the cathode 47.

Like the first embodiment, the mask patterns 34, 45 for formation of the mesh structure may be used as a portion of the insulating layer while they are not removed. In such a case, it is unnecessary to conduct the removal of the mask patterns, resulting in a reduced number of processes.

As described above, the present invention is advantageous in that the number of production processes of a field emission type cold-cathode device is reduced and an electrode structure of the cold-cathode device can be formed through a simple method.

What is claimed is:

1. A method of producing a field emission type cold-cathode device, comprising:
applying an insulating material on a thin conductive metal film;
etching the thin conductive metal film and insulating material to forme a gate and an insulating layer having a mesh structure;
forming a cathode on a predetermined substrate; and
mounting the insulating layer and gate having the mesh structure on an upper side of the cathode.

2. The method as set forth in claim 1, wherein the applying of the insulating material comprises forming a first insulating layer on one side of the thin conductive metal film.

3. The method as set forth in claim 1, wherein the applying of the insulating material comprises forming first and second insulating layers on both sides of the thin conductive metal film.

4. The method as set forth in claim 1, wherein the applying of the insulating material comprises:
forming a first insulating layer on a first thin conductive metal film;
forming a second thin conductive metal film on an upper side of the first insulating layer; and
forming a second insulating layer on an upper side of the second thin conductive metal film.

5. The method as set forth in claim 1, wherein the etching the thin conductive metal film and insulating material comprises:
forming a mask pattern using a photoresist on an upper side of the insulating layer formed on the thin conductive metal film; and
etching a remaining portion other than a portion protected by the mask pattern,
wherein, the mask pattern is not removed.

6. The method as set forth in claim 2, further comprising mounting a gate, on which an insulating layer is formed, on a cathode, and mounting a spacer made of the insulating material on an upper side of the gate.

7. The method as set forth in claim 3, wherein any one of the first and second insulating layers is positioned between a cathode and gates and the other is positioned between the gates and an anode, thus the first and second insulating layers act as spacers for maintaining an interval between the anode and cathode.
